(19) United States
(12) Patent Application Publication
(10) Pub. No.: US 2009/0249343 A1
(43) Pub. Date: Oct. 1, 2009

(54) SYSTEM, METHOD, AND COMPUTER PROGRAM PRODUCT FOR RECEIVING TIMER OBJECTS FROM LOCAL LISTS IN A GLOBAL LIST FOR BEING USED TO EXECUTE EVENTS ASSOCIATED THEREWITH

(76) Inventors: Pirasenna Thiyagarajan, San Jose, CA (US); Venu Vadapalli, Sunnyvale, CA (US)

Correspondence Address: ZILKA-KOTAB, PC- RMI, P.O. BOX 721120, SAN JOSE, CA, 95172-1120, US

(21) Appl. No.: 12/055,061

(22) Filed: Mar. 25, 2008

(51) Int. Cl. G06F 9/46

(52) U.S. Cl. 718/102

(57) ABSTRACT

A system, method, and computer program product are provided for receiving timer objects from local lists in a global list for being used to execute events associated therewith. A plurality of execution contexts are provided for receiving timer objects. Additionally, a plurality of local lists are provided, each corresponding with one of the execution contexts, for receiving the timer objects therefrom. Furthermore, a global list is provided for receiving the timer objects from the local lists for being used to execute events associated therewith.

### FIELD OF THE INVENTION

The present invention relates to computer architectures, and more particularly to timing management and scheduling in computing environments. BACKGROUND

Timer management and reliable scheduling is one of the most important pieces of software in an operating environment. In a highly asynchronous environment, the number of timers being managed (e.g. added, removed, dispatched, etc.) is extremely high. For example, software applications request asynchronous events to be triggered by the underlying operating environment.

Typically, these events are to be added to a list of existing events, tracked in the scale of time, executed when the requested time has elapsed, or deleted upon request. In the past, the cost of maintaining data structures used to manage the events has been passed to the applications, during the process of addition or removal of events. This model does not scale particularly well in systems where there are many instances of software running simultaneously and accessing common data structures (e.g. an event database, etc.).

In standard implementations, there are various concepts called timer wheels or radix insertions, B-trees (generalized balanced trees) or red-black trees (RB-trees), used to optimize the insertion or removal of events from the event database. In some cases, these implementations reduce the amount of time it may cost the application but they do not completely obviate the cost.

For example, FIG. 1 shows a system 100 for timer object management, in accordance with the prior art. As shown, multiple execution contexts 102 are provided, where the execution contexts 102 may include different application instances. Furthermore, an operating system layer 104, and a global list 106 are provided.

In operation, the execution contexts 102 request timer objects to be added asynchronously to the operating system layer 104 such that an event corresponding to the timer object may be triggered in the future. As a result, the timer object is added to the global list 106 which is being maintained by the operating system layer 104. In order to maintain the global list 106, a timer wheel 108, which is an advanced data structure to maintain the timer objects, is utilized. In this case, the timer wheel 108 is a window where the new timer objects that are received may be inserted into the global list 106.

As the number of execution contexts 102 grows, the number of timing objects to be inserted in the global list 106 also grows. Because the global list 106 is shared by all of the execution contexts 102, each of execution contexts 102 must insert the timer objects into the global list 106. However, when one of the execution contexts 102 is accessing the global list 106, the global list 106 is locked and no other execution context 102 may access the global list 106.

Thus, all other execution contexts 102 must wait until the execution context accessing the global list 106 has completed before one of the other execution contexts 102 may access the global list 106. This is a major cost to the application. Furthermore, the cost increases as the number of execution contexts 102 increase, as every execution context 102 will have to wait for the each other execution context 102 to access the global list 106 and insert corresponding timer objects.

There is thus a need for addressing these and/or other issues associated with the prior art.

### SUMMARY

A system, method, and computer program product are provided for receiving timer objects from local lists in a global list for being used to execute events associated therewith. A plurality of execution contexts are provided for receiving timer objects. Additionally, a plurality of local lists are provided, each corresponding with one of the execution contexts, for receiving the timer objects therefrom. Furthermore, a global list is provided for receiving the timer objects from the local lists for being used to execute events associated therewith.

### DESCRIPTION OF THE DRAWINGS

FIG. 1 shows a system for timer object management, in accordance with the prior art.

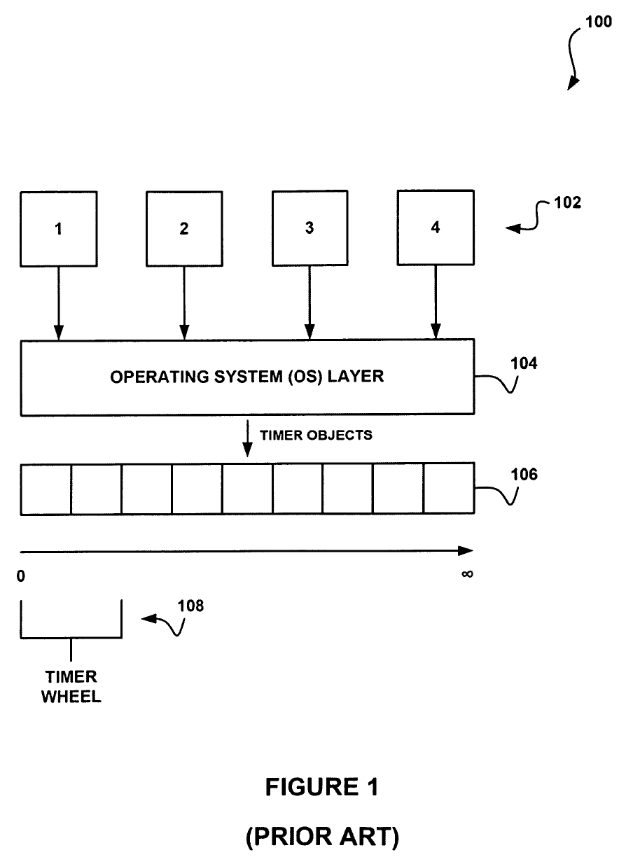

FIG. 2 shows a system for receiving timer objects from local lists in a global list for being used to execute events associated therewith, in accordance with one embodiment.

FIG. 3 shows a global list for receiving timer objects from the local lists, in accordance with one embodiment.

FIG. 4 shows a method for timer object insertion in a global list from local list, each corresponding to an execution context, in accordance with one embodiment.

FIG. 5 illustrates an exemplary system in which the various architecture and/or functionality of the various previous embodiments may be implemented.

### DETAILED DESCRIPTION

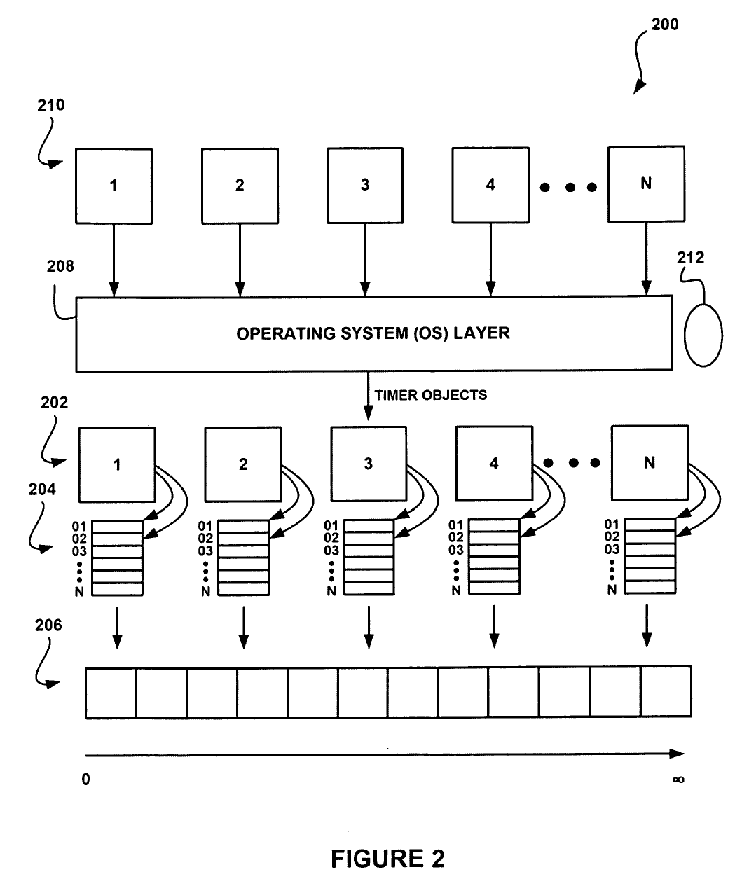

FIG. 2 shows a system 200 for receiving timer objects from local lists in a global list for being used to execute events associated therewith, in accordance with one embodiment. As shown, a plurality of execution context-specific kernel tasks 202 (i.e. execution contexts) are provided for receiving timer objects. In the context of the present description, an execution context refers to any instance of execution. For example, in various embodiments, the execution context may include, but is not limited to, an application instance, a thread of a processor, and/or any other execution context that meets the above definition. In one embodiment, the execution contexts may each correlate with one of a plurality of cores of a multi-core processor.

Furthermore, in the context of the present description, timer objects refer to any information, including timing information, associated with an event. For example, in various embodiments, the timer object may include a unique identifier, a call back, an expiry time, and/or any other information that meets the above definition. In one embodiment, the timer objects may have an un-compressed format. Further, the event may be any event to be triggered beginning at some specific time, or within a time period.

Additionally, a plurality of local lists 204 are provided, each corresponding with one of the execution contexts 202, for receiving the timer objects therefrom. For example, the local lists 204 may be populated with the timer objects in accordance with an order in which the timer objects are received in the local lists 204. Furthermore, a global list 206 is provided for receiving the timer objects from the local lists 204 for being used to execute events associated therewith. In this case, the global list may be populated with the timer objects in accordance with the order in which the timer objects are received in the local lists 204.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

With further respect to FIG. 2, certain kernel logic may be performed by the operating system outside of the context of any abstract execution contexts 210. Such kernel logic may be represented as the execution context-specific kernel tasks 202. These execution context-specific kernel tasks 202 may reside beneath an operating system layer 208. Further, a plurality of abstract execution contexts 210 may reside above the operating system layer 208. In this case, the abstract execution contexts 210 may be different and separate from the execution contexts 202, which may also referred to as “true” execution contexts.

For example, the execution context-specific kernel tasks 202 may include hardware assisted execution contexts, or execution contexts established by the operating system layer 208. The abstract execution contexts 210 may be part of an abstraction layer provided by the operating system layer 208. In this case, the abstract execution contexts 210 may be any instance of an execution context as managed by the operating system layer 208.

In operation, the abstract execution contexts 210 may request an asynchronous event to be added to the global list 206. The execution context-specific kernel tasks 202 may then receive a timer object via the operating system layer 208. In this case, the timer object may include a unique identifier to identify the timer object, a call back including information on actions to occur upon expiration of the timer object, and an expiration time indicating when the timer object will expire.

Once the timer objects are received, the execution context-specific kernel tasks 202 are able to determine at what point the timer is to expire, and the timer object is placed in the local list 204 corresponding to that execution context 202. It should be noted that since the local list is specific to exactly one of the abstract execution contexts, there is no blocking of other contexts in order to add the timer object into the local list. Subsequently, and periodically, logic is then used to add the timer objects from the local lists 204 into the global list 206 for being used to execute events associated therewith. In various embodiments, the events may include at least one of an add event, a remove event, and an expiry event.

It should be noted that, because each execution context 202 includes a corresponding local list 204, the local lists 204 may be populated with the timer objects while avoiding a locking function. For example, a first execution context 202 may write timer objects to a first local list 204 while a second execution context 202 writes timer objects to a second local list 204, while both the first and the second local lists remain unlocked. Similarly, all of the execution context-specific kernel tasks 202 may write to their local lists without being locked. In this way, neither any abstract execution context 210 nor any execution context-specific kernel task 202 is locked-out from writing timer objects its own local timer list.

The global list 206 may also be populated with the timer objects while avoiding a locking function. This may be accomplished by using logic within a single non-preemptive operating system call for extracting the timer objects from the local lists 204 to the global list 206. Because, none of the execution context-specific kernel tasks 202 ever insert timer objects directly into the global list 206, the global list 206 may remain unlocked.

Thus, all of the lists used for timer object storage, namely each and every of the local lists 204 and the global list 206 may remain unlocked. By allowing the operating system layer 208 to function without locking any of the lists, operating system layer resources may be utilized on other tasks, thereby increasing efficiency of the operating system layer 208. Furthermore, the operating system layer 208 may implement a linear scan or a merge sort to write the timer objects included in the local lists 204 to the global list 206.

In one embodiment, the operating system layer 208 may include auditing logic 212 capable of maintaining the global list 206. This auditing logic 206 may be utilized to correlate the local lists 204 with the global list 206, such that the auditing logic 212 has sole access to the global list 206. Thus, the execution context-specific kernel tasks 202 may continue to write timer objects to the local lists 204, while the global list 206 is being written with timer objects without the execution context-specific kernel tasks 202 having to wait for the global list 206 to unlock.

In this way, the cost of insertion and triggering and deletion of timer objects from a timer database (i.e. a global list) may be reduced or nearly eliminated, thereby reducing jitter in application behavior. Additionally, the cost of timer ordering may be minimized to a unit polynomial complexity. Furthermore, a dispatch scheme may be implemented where the cost of executing the timer is distributed across various processors in a multi-core environment. It should be noted that, the aforementioned functionality may be implemented in the context of a single processor system, as well as a multiple processor system.

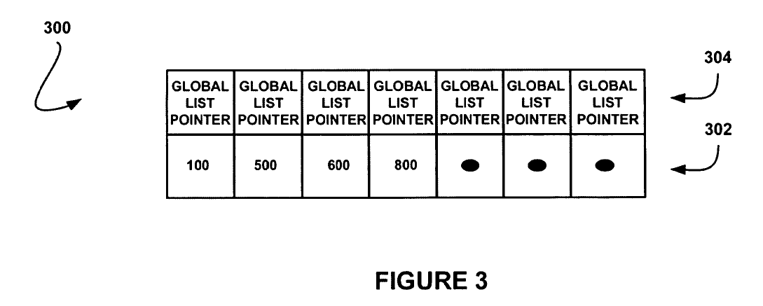

FIG. 3 shows a global list 300 for timer object insertion in a global list from local lists, each corresponding to an execution context, in accordance with one embodiment. As an option, the global list 300 may be viewed in the context of FIG. 2. Of course, however, the global list 300 may be viewed in the context of any desired environment. It should also be noted that the aforementioned definitions may apply during the present description.

As shown, the global list 300 includes an arbitrary number of tuples, each containing a row of first cells 302 and a row of second cells 304. In this case, a tuple refers to a time and pointer pair, and a row refers to a sequence (i.e. an ordered list) of such pairs. As shown further, each one of the first cells 302 may include a time for a given instance (e.g. a time at some point in the future), which depends on timer granularity. Also, each tuple's second cell 304 may include pointer to a specific location in the global list 206, of FIG. 2.

Using the time value of the first cells 302 and the pointer value of the second cells 304, timer objects may be inserted into the global list 300 corresponding to specific time Thus, using the rows of tuples 302 and 304, a precise pointer to the beginning and end of a relatively nary range of the global list can be identified. In the example shown, if a timer object to be inserted into the global list at time=650, then using the tuples, the logic can know that 650 must occur between the list element in the global list pointed to by the pointer value corresponding to 600 and the list element in the global list pointed to by the pointer value corresponding to 800. Of course this is an example only, and in embodiments the value of the successive time values can be of any granularity, and may be tuned such that there exists time values in the row of cells which correspond to specific and common timer points (e.g. 100 microseconds from now, 800 milliseconds from now, etc).

Continuing with the discussion of FIG. 3, it should be noted that empirically, the closer the timer expiry, the more precise and deterministic the disposition of a timer expiry should be; at least in order to reduce application jitter. Thus, even though the system of FIG. 2 may support a huge dynamic range (e.g. from a few microseconds to days) the number of tuples need only be as many as are convenient, and may even be limited to time ranges less than or equal to the time until the next execution of the auditing logic 212.

Using the above technique, even an O(n) linear search of portions of the global list 300 are acceptable since only a relatively small segment of the global list 300 need be searched. Thus, complicated data structures for searching and updating the global list 300 may be avoided.

Furthermore, a catch-all bucket that holds timers set to expire in distant future may be stored in an ordered list. The auditing logic which executes periodically may visit this catch-all bucket to promote those timer objects into more recent lists. Upon each visit, the auditing logic may record the next time it should visit the list based on the first expiring entry in this bucket. Since the entries in this bucket expire in the distant future, the visits to this bucket for promotion are very minimal. It should be noted that the granularity of the operating system timers may be much greater than the periodicity of the running of the auditing logic. This may avoid a situation where an execution context tries to schedule a timer for expiration at a time sooner than when the audit logic runs, for example.

Returning to the discussion of the auditing logic 212 introduced above, the auditing logic 212 may execute periodically and non-preemptively, and operates to order timer objects into the global list 300. It should be noted even though the global list may contain timer objects with expiry both very near and also very far into the future, the auditing logic 212 need only precisely insert time objects within the time horizon as defined by the rightmost tuple of FIG. 3. In other words, a precise ordering of timer objects having an expiry far in the future is inconsequential. On the contrary, as the time horizon is near, the precision of the list insertion may be relevant. From this observation, the auditing task 212 need not be concerned with the order of timer object beyond the time horizon specified by the rightmost time value in the row of cells 304. This relaxation permits a run-time of the auditing logic 212 that is only slightly greater than O(n) where n is the number of timer objects.

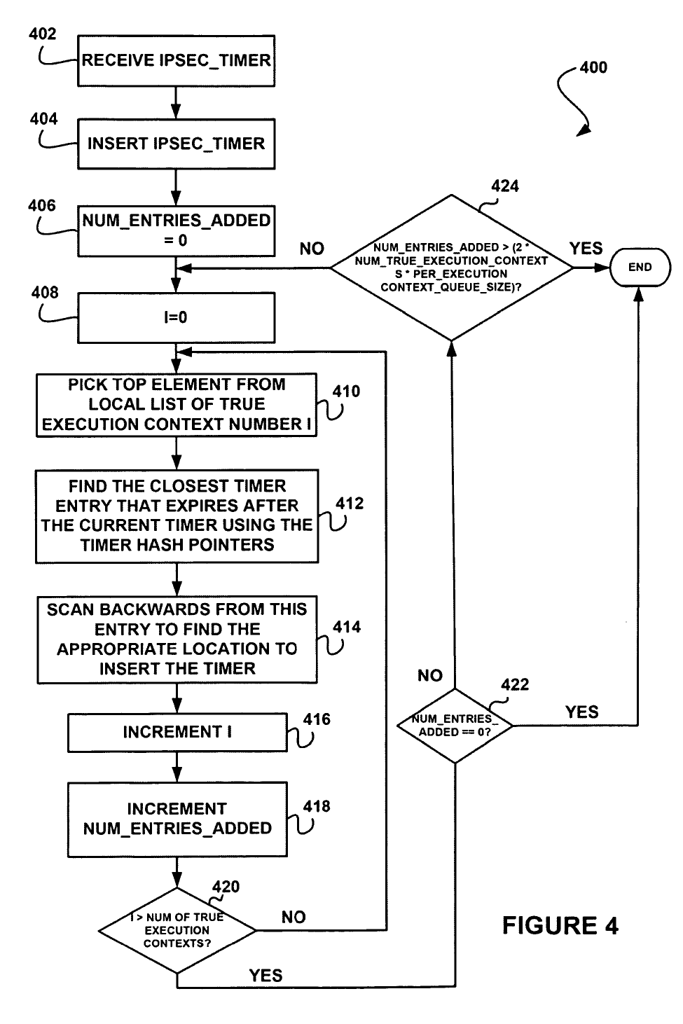

FIG. 4 shows a method 400 for timer object insertion to a global list from a local list corresponding to an execution context, in accordance with one embodiment. As an option, the present method 400 may be implemented in the context of the functionality and architecture of FIGS. 2-3. Of course, however, the method 400 may be carried out in any desired environment. Again, the aforementioned definitions may apply during the present description.

As shown, a timer object is received by a local list corresponding to an execution context. See operation 402. The timer object is then inserted into the local list. See operation 404.

A counter indicating the number of entries added to the list (“num_entries_added”) is then set to zero. See operation 406. In addition to setting the counter indicating the number of entries added to zero, a variable indicating the execution context number (“I”) is also set to zero. See operation 408.

Once the variable indicating the context number is set to zero, the top element of the local list corresponding to the execution context number “I” is selected. See operation 410. In the first instance, the top element from the execution context “0” would be selected, which corresponds to the first execution context. In this case, the local list may include a first in first out buffer.

Once the top element from the execution context has been selected, the closest timer entry that expires after the current timer object is found using timer hash pointers. See operation 412. It should be noted that, in some cases, timer entries to be executed far in the future may not need to be sorted.

Once the closest timer entry that expires after the current timer object has been found, an appropriate location to insert the timer object in the global list is found by scanning backwards from the found timer entry. See operation 414. Once found, the timer object is inserted into the global list.

After the timer is inserted into the global list, the variable “I” indicating the context number is incremented by one. See operation 416. Additionally, the counter indicating the number of entries added to the list is incremented by one. See operation 418.

It is then determined whether the variable “I” indicating the context number is greater than the number of true execution contexts. See operation 420. If the variable “I” indicating the context number is not greater than the number of true execution contexts, the top element of the local list corresponding to the execution context number “I” is selected and operations 412-420 are repeated.

On the other hand, if the variable “I” indicating the context number is greater than the number of true execution contexts, it is determined whether the counter indicating the number of entries added to the list is equal to zero. See operation 422. If it is determined that the number of entries added to the list is equal to zero, the sequence is ended.

If it is determined that the number of entries added to the list is not equal to zero, it is then determined whether the number of entries added to the list is greater than two times the number of true execution contexts times the local list size of the execution context. If the number of entries added to the list is no greater than this value, the variable “I” indicating the context number is reset to zero and operations 410-420 are repeated. If the number of entries added to the list is greater than this value, the sequence is ended.

In this way, the local list of each execution context may be scanned for the earliest entry and added to the global timer list in the correct location. In one embodiment, this may be implemented in O(n) time complexity, due to the maintenance of the timer objects in chronological order within the true execution context list. As such, a merge sort may be implemented.

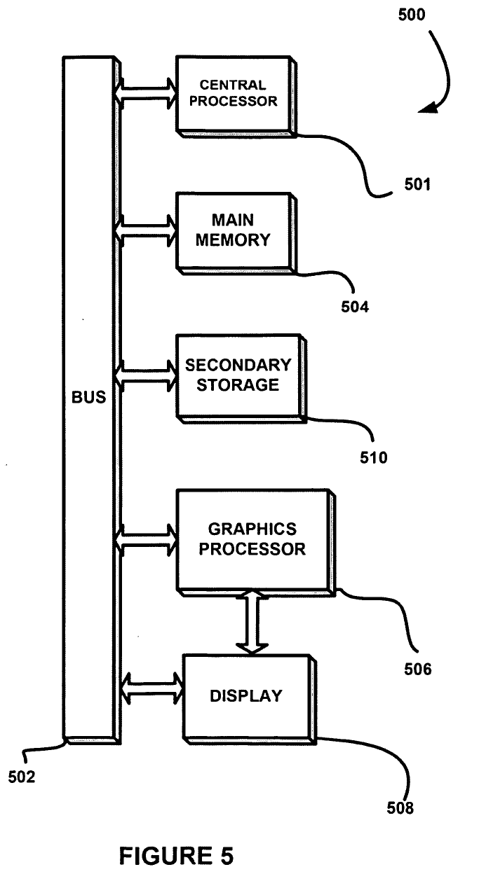

FIG. 5 illustrates an exemplary system 500 in which the various architecture and/or functionality of the various previous embodiments may be implemented. As shown, a system 500 is provided including at least one host processor 501 which is connected to a communication bus 502. The system 500 also includes a main memory 504. Control logic (software) and data are stored in the main memory 504 which may take the form of random access memory (RAM).

The system 500 also includes a graphics processor 506 and a display 508, i.e. a computer monitor. In one embodiment, the graphics processor 506 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 500 may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 504 and/or the secondary storage 510. Such computer programs, when executed, enable the system 500 to perform various functions. Memory 504, storage 510 and/or any other storage are possible examples of computer-readable media.

In one embodiment, the architecture and/or functionality of the various previous figures may be implemented in the context of the host processor 501, graphics processor 506, an integrated circuit (not shown) that is capable of at least a portion of the capabilities of both the host processor 501 and the graphics processor 506, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, lap-top computer, and/or any other type of logic. Still yet, the system 500 may take the form of various other devices including, but not limited to, a personal digital assistant (PDA) device, a mobile phone device, a television, etc.

Further, while not shown, the system 500 may be coupled to a network [e.g. a telecommunications network, local area network (LAN), wireless network, wide area (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer program product embodied on a computer readable medium, comprising:
a plurality of execution contexts for receiving timer objects;
a plurality of local lists each corresponding with one of the execution contexts for receiving the timer objects therefrom; and
a global list for receiving the timer objects from the local lists for being used to execute events associated therewith.

2. The computer program product of claim 1, wherein the timer objects include an expiry time.

3. The computer program product of claim 1, wherein the timer objects include a call back.

4. The computer program product of claim 1, wherein the timer objects include a unique identifier.

5. The computer program product of claim 1, wherein the events include at least one of an add event, a remove event, and an expiry event.

6. The computer program product of claim 1, wherein the local lists are populated with the timer objects in accordance with an order in which the timer objects are received in the local lists.

7. The computer program product of claim 6, wherein the global list is populated with the timer objects in accordance with the order in which the timer objects are received in the local lists.

8. The computer program product of claim 1, wherein the timer objects have an un-compressed format.

9. The computer program product of claim 1, wherein the execution contexts reside beneath an operating system layer.

10. The computer program product of claim 9, wherein a plurality of abstract execution contexts reside above the operating system layer.

11. The computer program product of claim 1, wherein the execution contexts each correlate with one of a plurality of cores of a multi-core processor.

12. The computer program product of claim 1, wherein the local lists are populated with the timer objects while avoiding a locking function.

13. The computer program product of claim 1, wherein the global list is populated with the timer objects while avoiding a locking function.

14. A system, comprising:
a plurality of execution contexts for receiving timer objects;
a plurality of local lists each corresponding with one of the execution contexts for receiving the timer objects therefrom; and
a global list for receiving the timer objects from the local lists for being used to execute events associated therewith.

15. The system of claim 14, wherein the timer objects include an expiry time.

16. The system of claim 14, wherein the timer objects include a call back.

17. The system of claim 14, wherein the timer objects include a unique identifier.

18. The system of claim 14, wherein the events include at least one of an add event, a remove event, and an expiry event.

19. The system of claim 14, wherein the local lists are populated with the timer objects in accordance with an order in which the timer objects are received in the local lists.

20. A method, comprising:
receiving timer objects via a plurality of execution contexts;
receiving the timer objects from the execution contexts in a plurality of local lists each corresponding with one of the execution contexts; and
receiving the timer objects from the local lists in a global list for being used to execute events associated therewith.
